(19) United States
(12) Patent Application Publication
(10) Pub. No.: US 2025/0091472 A1
(43) Pub. Date: Mar. 20, 2025

(54) BATTERY MANAGEMENT SYSTEM, BATTERY MANAGEMENT METHOD, AND TERMINAL DEVICE

(71) Applicant: Panasonic Intellectual Property Management Co., Ltd., Osaka (JP)

(72) Inventors: Manano TAGUCHI, Kanagawa (JP); Masashi TAKEMURA, Kanagawa (JP); Ryota SAITO, Kanagawa (JP)

(73) Assignee: Panasonic Intellectual Property Management Co., Ltd., Osaka (JP)

(21) Appl. No.: 18/727,304

(22) PCT Filed: Dec. 28, 2022
(86) PCT No.: PCT/JP2022/048518

§ 371 Date: Jul. 8, 2024

(30) Foreign Application Priority Data
Jan. 12, 2022 (JP) 2022-003268

(51) Int. Cl. B60L 53/80; B60L 53/30; B60L 53/62; B60L 53/66; G06Q 30/0645

(52) U.S. Cl. CPC B60L 53/80; B60L 53/305; B60L 53/62; B60L 53/66; G06Q 30/0645; B60L 2240/72

(57) ABSTRACT

A management server stores administrator setting information for managing an expanded rental mode for each battery station based on specification by an administrator, controls, by referring to the administrator setting information, switching between the expanded rental mode and a normal rental mode which permits rental of only fully charged battery devices at each battery station, and displays a station guidance screen on a user terminal, the station guidance screen providing the user with guidance on the battery stations based on control of the rental mode thereof and including information on a transition state to the expanded rental mode at each battery station.

### TECHNICAL FIELD

The present disclosure relates to a battery exchange service which enables users of electric vehicles or the like to exchange battery devices at battery stations, and more particularly, to a battery management system and a battery management method for managing the battery stations and the battery devices and to a terminal device carried by each user.

### BACKGROUND ART

In recent years, electric vehicles such as electric motorcycles have attracted attention from the viewpoint of solving the problems of air pollution due to exhaust gas and high fuel costs. The cruising ranges of such electric vehicles are progressively extended owing to the improvement in the performance of battery devices, but such electric vehicles may cause inconvenience since they cannot travel continuously for a long time due to the necessity for charging the battery devices. In order to eliminate such inconvenience, there has been put into practice a conventional battery exchange service that enables the electric vehicles to travel continuously for a long time by fitting the electric vehicles with detachable battery devices so that exhausted battery devices can be exchanged with fully charged battery devices at battery stations (see Patent Document 1).

On the other hand, at each battery station, fully charged (charging completed) battery devices may not be always prepared. Therefore, when there is no fully charged battery device, users may have to wait until the charging is completed and the battery devices that can be rented are prepared, and this is inconvenient to the users. Thus, conventionally, there is known a technology in which in a case where there is a shortage of fully charged battery devices, battery devices reaching a predetermined state of charge are rented to the users (see Patent Document 1).

### PRIOR ART DOCUMENT(S)

### Patent Document(s)

Patent Document 1: JPH11-259709A

### SUMMARY OF THE INVENTION

### Task to be Accomplished by the Invention

According to the conventional technology, normally, operation is carried out with a rental mode permitting rental of only fully charged battery devices, and in a case where there is a shortage of fully charged battery devices, the mode transitions to a rental mode permitting rental of incompletely charged battery devices if they satisfy a predetermined condition. Thus, according to the conventional technology, in a case where there is a shortage of fully charged battery devices, the rental of battery devices is continued by expanding the range permitted to be rented, whereby the user convenience can be enhanced.

On the other hand, in some cases, the users may not want incompletely charged battery devices to be rented. Therefore, when providing the user with guidance on battery stations for battery exchange, it is desired to provide sufficient information to the user in relation to that the normal rental mode has switched to the special rental mode in which the range of battery devices permitted to be rented is expanded and that the battery devices to be rented are incompletely charged.

In view of the above, a primary object of the present disclosure is to provide a battery management system, a battery management method, and a terminal device that can provide sufficient information to the user regarding expanding the range of battery devices permitted to be rented and renting incompletely charged battery devices which are normally not rented in a case where there is a shortage of fully charged battery devices at battery stations.

### Means to Accomplish the Task

A battery management system of the present disclosure is a battery management system, comprising: a plurality of battery exchange devices located in respective battery stations and configured to store and charge battery devices returned by users and to rent charged battery devices to the users in exchange for the returned battery devices; a server device connected to the plurality of battery exchange devices via a network and configured to manage exchanging states of the battery devices at the battery exchange devices; and a terminal device carried by a user and connected to the server device via the network, wherein the server device is configured to store setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station, control, by referring to the setting information, switching between the expanded rental mode and a normal rental mode which permits rental of only fully charged battery devices at each battery station, and display a guidance screen on the terminal device, the guidance screen providing the user with guidance on the battery stations based on control of the rental mode thereof and including information on a transition state to the expanded rental mode at each battery station.

Also, a battery management method of the present disclosure is a battery management method used by a server device for managing battery stations where users exchange battery devices and for managing the battery devices, the battery management method comprising: storing setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station; controlling, by referring to the setting information, switching between the expanded rental mode and a normal rental mode which permits rental of only fully charged battery devices at each battery station; and displaying a guidance screen on a terminal device, the guidance screen providing the user with guidance on the battery stations based on control of the rental mode thereof and including information on a transition state to the expanded rental mode at each battery station.

Also, a terminal device of the present disclosure is a terminal device carried by a user and connected to a server device via a network, the terminal device being configured to display a guidance screen that provides the user with guidance on battery stations according to control of switching between an expanded rental mode which permits rental of incompletely charged battery devices satisfying a predetermined expanded rental condition in a case where there is a shortage of fully charged battery devices at each battery station and a normal rental mode which permits rental of only fully charged battery devices at each battery station, and includes information on a transition state to the expanded rental mode at each battery station, the control being conducted by the server device based on specification by an administrator.

### Effect of the Invention

According to the present invention, it is possible to provide sufficient information to the user regarding expanding the range of battery devices permitted to be rented and renting incompletely charged battery devices which are normally not rented (expanded rental mode) when there is a shortage of fully charged battery devices at battery stations.

### BRIEF DESCRIPTION OF THE DRAWINGS

FIG. 1 is an overall schematic diagram of a battery sharing system according to an embodiment;

FIG. 2 is a block diagram showing schematic configurations of a battery exchanger 3, a management server 4, and a user terminal 5;

FIG. 3 is an explanatory diagram showing an overview of the process executed by the management server 4;

FIG. 4 is a block diagram showing the content of profile information for each user;

FIG. 5 is an explanatory diagram showing a use state confirmation screen displayed on the management terminal 6;

FIG. 6 is an explanatory diagram showing a login screen and a start screen displayed on the user terminal 5;

FIG. 7 is an explanatory diagram showing a profile setting screen and a profile registration completion screen displayed on the user terminal 5;

FIG. 8 is an explanatory diagram showing a detailed search screen displayed on the user terminal 5;

FIG. 9 is an explanatory diagram showing a station guidance screen displayed on the user terminal 5;

FIG. 10 is an explanatory diagram showing the station guidance screen displayed on the user terminal 5;

FIG. 11 is an explanatory diagram showing a reservation screen and a reservation completion screen displayed on the user terminal 5;

FIG. 12 is an explanatory diagram showing an alert screen displayed on the user terminal 5;

FIG. 13 is a sequence diagram showing operation procedures of the user terminal 5 and the management server 4 at login and when the profile is set;

FIG. 14 is a sequence diagram showing operation procedures of the user terminal 5 and the management server 4 when automatic search is selected and when detailed search is selected; and

FIG. 15 is a sequence diagram showing operation procedures of the user terminal 5 and the management server 4 when a reservation is made.

### MODE(S) FOR CARRYING OUT THE INVENTION

A first aspect of the invention made to achieve the object is a battery management system, comprising: a plurality of battery exchange devices located in respective battery stations and configured to store and charge battery devices returned by users and to rent charged battery devices to the users in exchange for the returned battery devices; a server device connected to the plurality of battery exchange devices via a network and configured to manage exchanging states of the battery devices at the battery exchange devices; and a terminal device carried by a user and connected to the server device via the network, wherein the server device is configured to store setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station, control, by referring to the setting information, switching between the expanded rental mode and a normal rental mode which permits rental of only fully charged battery devices at each battery station, and display a guidance screen on the terminal device, the guidance screen providing the user with guidance on the battery stations based on control of the rental mode thereof and including information on a transition state to the expanded rental mode at each battery station.

According to this aspect, it is possible to provide sufficient information to the user regarding expanding the range of battery devices permitted to be rented and renting incompletely charged battery devices which are normally not rented (expanded rental mode) when there is a shortage of fully charged battery devices at battery stations.

In a second aspect of the invention, the server device is configured to cause the terminal device to display the guidance screen in which battery stations where rental of the battery devices is possible in the expanded rental mode are superimposed on a map. According to this aspect, guidance on the battery stations where the battery devices can be rented in the expanded rental mode can be provided to the user in an easy-to-understand manner.

In a third aspect of the invention, the server device is configured to hold, based on specification by the administrator, setting information regarding prohibition of transition to the expanded rental mode for each battery station, and control the expanded rental mode at each battery station based on the setting information.

According to this aspect, it is possible to prevent the control for transition to the expanded rental mode from being erroneously performed in a battery station where the expanded rental mode is inappropriate due to special circumstances.

In a fourth aspect of the invention.

According to this aspect, it is possible to accept the battery exchange reservation made by the user.

In a fifth aspect of the invention, the server device is configured to acquire information regarding battery exchange reservation according to an operation by the user on the guidance screen displayed on the terminal device.

According to this aspect, the expanded rental mode at each battery station can be controlled more properly.

In a sixth aspect of the invention, the server device is configured to determine whether transition to the expanded rental mode should be permitted by analyzing history information regarding a past rental status at each battery station.

According to this aspect, labor in the work of setting the expanded rental mode at each battery station is saved, and thus, the burden on the administrator when the number of battery stations to be managed increases can be reduced.

A seventh aspect of the present invention is a battery management method used by a server device for managing battery stations where users exchange battery devices and for managing the battery devices, the battery management method comprising: storing setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station; controlling, by referring to the setting information, switching between the expanded rental mode and a normal rental mode which permits rental of only fully charged battery devices at each battery station; and displaying a guidance screen on a terminal device, the guidance screen providing the user with guidance on the battery stations based on control of the rental mode thereof and including information on a transition state to the expanded rental mode at each battery station.

According to this aspect, as in the first aspect of the invention, it is possible to provide sufficient information to the user regarding expanding the range of battery devices permitted to be rented and renting incompletely charged battery devices which are normally not rented (expanded rental mode) when there is a shortage of fully charged battery devices at battery stations.

An eighth aspect of the invention is a terminal device carried by a user and connected to a server device via a network, the terminal device being configured to display a guidance screen that provides the user with guidance on battery stations according to control of switching between an expanded rental mode which permits rental of incompletely charged battery devices satisfying a predetermined expanded rental condition in a case where there is a shortage of fully charged battery devices at each battery station and a normal rental mode which permits rental of only fully charged battery devices at each battery station, and includes information on a transition state to the expanded rental mode at each battery station, the control being conducted by the server device based on specification by an administrator.

According to this aspect, as in the first aspect of the invention, it is possible to provide sufficient information to the user regarding expanding the range of battery devices permitted to be rented and renting incompletely charged battery devices which are normally not rented (expanded rental mode) when there is a shortage of fully charged battery devices at battery stations.

In the following, an embodiment of the present disclosure will be described with reference to the appended drawings.

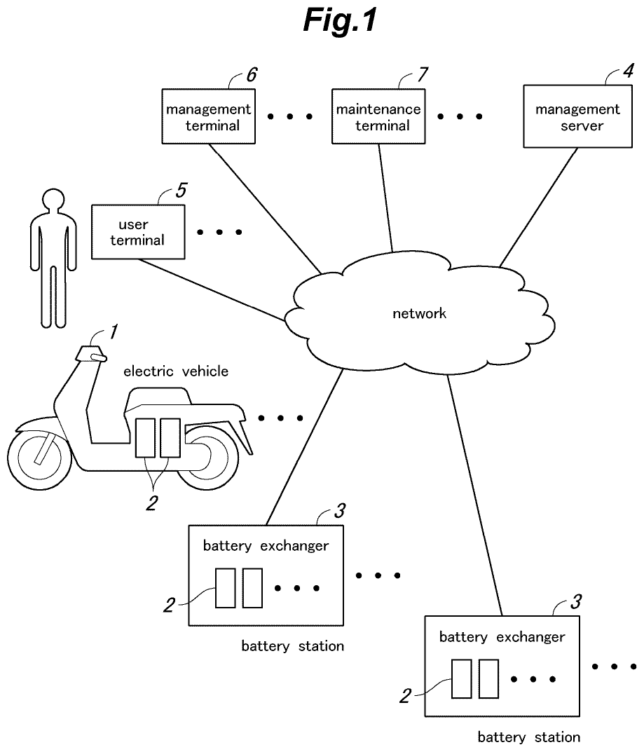

FIG. 1 is an overall schematic diagram of a battery sharing system according to an embodiment of the present invention.

This battery sharing system is configured to provide a service (battery exchange service) in which battery packs 2 (battery devices) fitted to electric vehicles 1 such as electric motorcycles can be shared among a plurality of users, and includes battery exchangers 3 (battery exchange devices), a management server 4 (server device), user terminals 5 (terminal devices), management terminals 6, and maintenance terminals 7.

The battery exchangers 3, the management server 4, the user terminals 5, the management terminals 6, and the maintenance terminals 7 are connected via a network such as the Internet. The battery exchangers 3 and the user terminals 5 are connected to the network via a wireless communication such as a mobile communication network and a wireless LAN.

Each electric vehicle 1 is fitted with the battery packs 2, and travels on the electric power of the battery packs 2. The electric vehicle 1 consists of an electric motorcycle in the example shown in FIG. 1, but may also consist of a four-wheeled vehicle. Further, the electric vehicle 1 may be a mobility device not designed for public roads such as an electric wheelchair, an electric cart, or a riding cart for use in a theme park, a golf course, or the like.

Each battery exchanger 3 stores and charges the battery packs 2 returned by the users, and rents the charged battery packs 2 to the users in exchange for the returned battery packs 2. The battery exchangers 3 are installed in battery stations attached to facilities (stores) such as convenience stores and gas stations. A plurality of battery exchangers 3 are installed in each one of the battery stations. Note that in the present embodiment, even when the battery packs 2 are not fully charged, if the state of charge reaches a predetermined value (rental threshold) (expanded rental mode), the battery packs 2 are determined to be charged and are rented.

The management server 4 registers, as users (members), persons subscribing to the battery exchange service so as to use the battery packs 2, and manages the battery packs 2 in association with the users to whom the battery packs 2 are rented. Also, the management server 4 manages the exchanging states of the battery packs 2 in each battery exchanger 3. Also, the management server 4 monitors the state of each battery exchanger 3 (whether each battery exchanger 3 is online) and the states of the battery packs 2 stored in the battery exchanger 3 (whether the battery packs 2 are fully charged), and transmits the state information on the battery exchanger 3 and the battery packs 2 to the management terminals 6 and the maintenance terminals 7. Further, the management server 4 transmits information on an operation state of each battery station and the like to the user terminals 5.

Each user terminal 5 consists of a smartphone, a tablet terminal, or the like, and is carried by the user of the electric vehicle 1. The user terminal 5 displays various screens based on the information transmitted from the management server 4. By using these screens, the user terminal 5 guides the user through the position and operation state of each battery station, and enables the user to perform an operation for making a battery exchange reservation.

Each management terminal 6 is installed in a facility to receive the users such as a management center, and is operated by an administrator. On the management terminal 6, the administrator can perform an operation for user registration. Also, on the management terminal 6, the administrator can check the information transmitted from the management server 4.

Each maintenance terminal 7 is installed in a facility dedicated for a maintenance operation or a facility such as a store provided with the battery station, and is operated by a maintenance person. On the maintenance terminal 7, the maintenance person can check the information transmitted from the management server 4.

The battery packs 2 to be fitted to electric vehicles 1 are given as an example in the present embodiment, but battery devices to which the battery packs 2 are fitted are not limited to the electric vehicles 1, and may be portable power supply devices, for example.

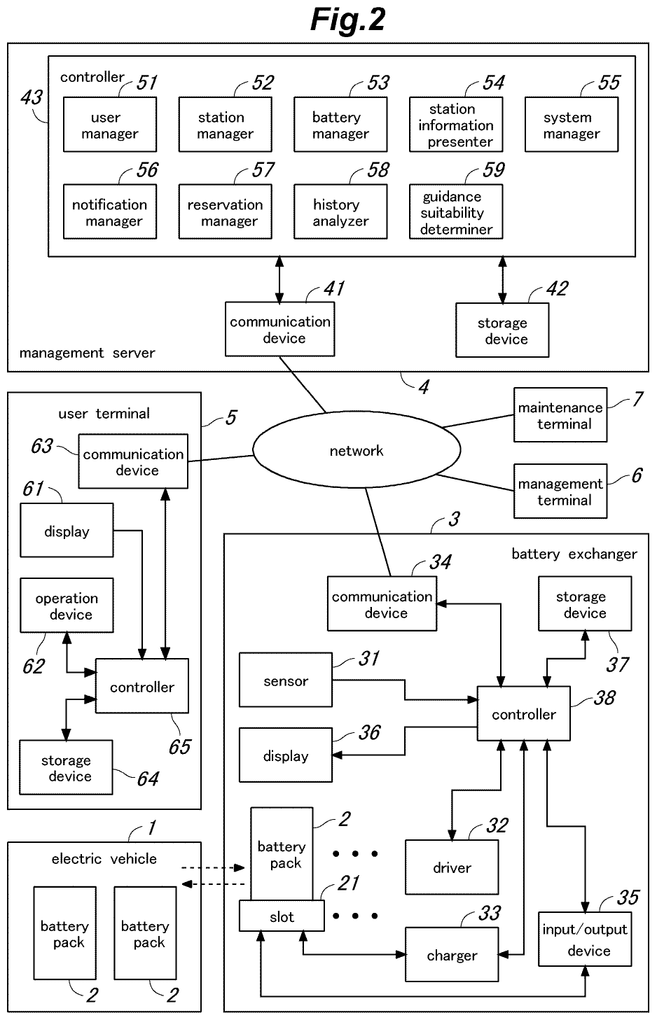

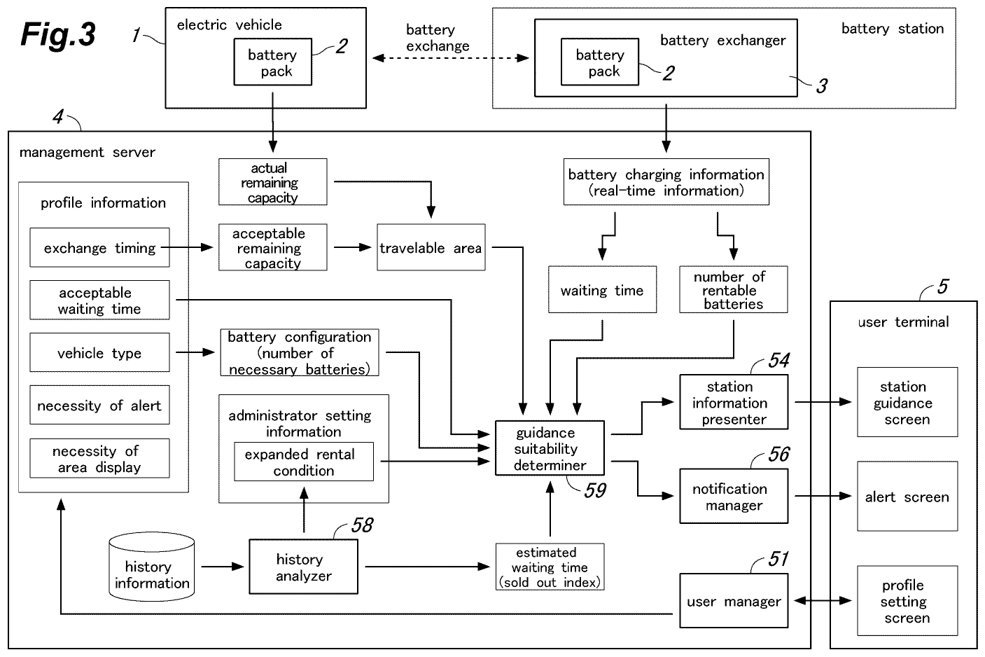

Next, schematic configurations of each battery exchanger 3, the management server 4, and each user terminal 5 will be described. FIG. 2 is a block diagram showing the schematic configurations of the battery exchanger 3, the management server 4, and the user terminal 5. FIG. 3 is an explanatory diagram showing an overview of the process executed by the management server 4.

Each battery exchanger 3 includes a sensor 31, a driver 32, a charger 33, a communication device 34, an input/output device 35, a display 36, a storage device 37, and a controller 38.

The sensor 31 consists of a human sensor, for example, and detects a person who visits the battery exchanger 3 for battery exchange.

Incidentally, the battery exchanger 3 may perform user authentication to identify the user who visits the battery exchanger 3 for the battery exchange. In this case, the battery exchanger 3 may identify the user by face recognition based on an image captured by a camera. Also, the battery exchanger 3 may identify the user by communicating with an RFID (Radio Frequency Identifier) tag or a non-contact type IC card carried by the user, or by communicating with each user terminal 5 equipped with an NFC (Near Field Communication) function. Further, the battery exchanger 3 may detect that the user is about to return each battery pack 2 by reading a two-dimensional code affixed to the battery pack 2 based on the image captured by the camera.

In response to an instruction from the controller 38, the driver 32 drives, upon return or rental of the battery packs 2, an opening/closing mechanism of an opening/closing door and a storing/dispensing mechanism for storing the returned battery packs 2 and dispensing the battery packs 2 to be rented to the users. Note that when the security at the time of battery exchange is ensured, the configuration of the storing/dispensing mechanism may be omitted.

The charger 33 charges the battery packs 2 via slots 21 (trays).

The communication device 34 communicates with the management server 4 via the network.

The input/output device 35 transmits and receives information to and from the battery packs 2. For example, the serial numbers, alerts, deterioration information on the battery packs 2 are received from the battery packs 2.

The display 36 displays a guidance screen for giving user guidance on exchange of the battery packs 2.

The storage device 37 stores programs and the like to be executed by the processor that constitutes the controller 38.

The controller 38 consists of a processor, and controls various parts of each battery exchanger 3. For example, the controller 38 controls the exchange of the battery packs 2. Namely, the controller 38 controls the driver 32 to cause the driver 32 to perform an operation for storing the battery packs 2 returned by the users and an operation to rent the charged battery packs 2 to the users. More specifically, when the sensor 31 detects each user, the controller 38 causes the driver 32 to start a battery exchange operation and thus to open the opening/closing door, thereby making the user return the battery packs 2.

Further, the controller 38 monitors the charging states and empty states of the battery packs 2 attached to the respective slots 21, and reports information thereon to the management server 4. Accordingly, the management server 4 can manage the charging states and empty states of the battery packs 2 in the battery exchanger 3. Then, the management server 4 generates a rental order list of the battery packs 2 and the like following the rental rule based on the charging states of the battery packs 2, and transmits the rental order list to the battery exchanger 3, whereby the battery exchanger 3 can perform efficient rental control when the user exchanges the battery packs 2 or makes a reservation of battery exchange. Note that instead of the management server 4, the battery exchanger 3 itself may control the rental order of the battery packs 2 following the rental rule based on the charging states of the battery packs 2.

The electric vehicle 1 is fitted with one or more battery packs 2. Further, the battery exchanger 3 stores a plurality of (for example, 8) battery packs 2. In a case where the electric vehicle 1 is fitted with a plurality of battery packs 2, the user can exchange the plurality of battery packs 2 at the same time. In the examples shown in FIGS. 1 and 2, the number of battery packs 2 fitted to the electric vehicle 1 is set to two, but the number of battery packs 2 may be one, or three or more.

The management server 4 includes a communication device 41, a storage device 42, and a controller 43.

The communication device 41 communicates with each battery exchanger 3, each user terminal 5, each management terminal 6, and each maintenance terminal 7 via the network.

The storage device 42 stores programs to be executed by the processor that constitutes the controller 43. Also, the storage device 42 stores management information such as user registration information, associating information that associates the battery packs 2 with the users to whom the battery packs 2 are rented.

The controller 43 includes a user manager 51, a station manager 52, a battery manager 53, a station information presenter 54, a system manager 55, a notification manager 56, a reservation manager 57, a history analyzer 58, and a guidance suitability determiner 59. The controller 43 consists of a processor, and the processor executes the programs stored in the storage device 42 to realize various components of the controller 43.

The user manager 51 manages the users who use the battery packs 2. For example, the administrator accepts applications for new registration from the users, and acquires and manages user information (user IDs, names, addresses, and vehicle types of electric vehicles 1 to be used) by operating each management terminal 6 (user registration).

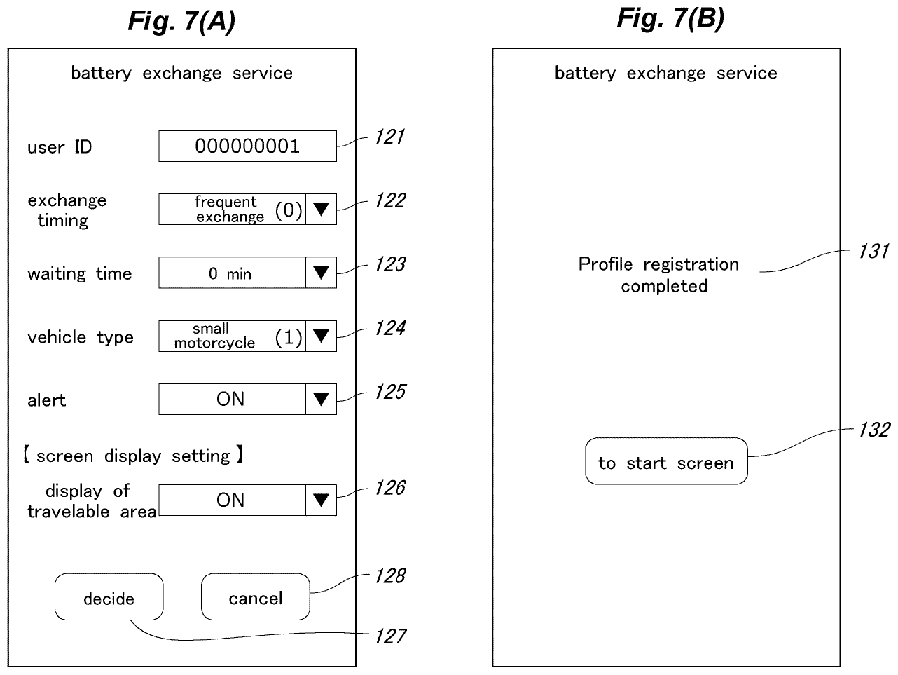

Further, the user manager 51 causes the user terminal 5 to display a profile setting screen (see FIG. 7(A)) for having the user input items regarding the requirements of the user for battery exchange (the user's preference, convenience, and the like) and, according to an operation by the user on the profile setting screen, acquires and manages the profile information (setting information) regarding the requirements of the user for battery exchange.

The station manager 52 manages each battery station and each battery exchanger 3 installed therein. More specifically, the station manager 52 collects from the battery exchanger 3 the information on the state (operating state or the like) of the battery exchanger 3 located in the battery station, and manages the collected information. Further, the station manager 52 collects from the battery exchanger 3 information on the state (charged state, empty state, or the like) of the battery packs 2 stored in the battery exchanger 3, and manages the collected information. Also, the station manager 52 may collect and manage, as the information on the state of the battery packs 2, information such as the degraded state, the use period, and the number of exchanges.

The battery manager 53 manages the battery packs 2 stored in each battery exchanger 3 and the battery packs 2 that are being rented to the users.

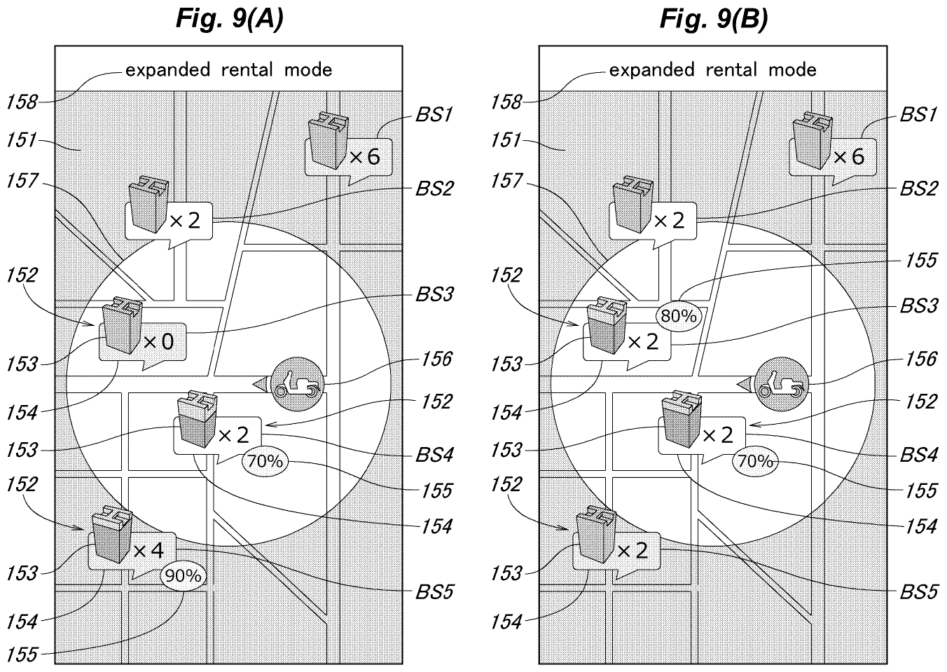

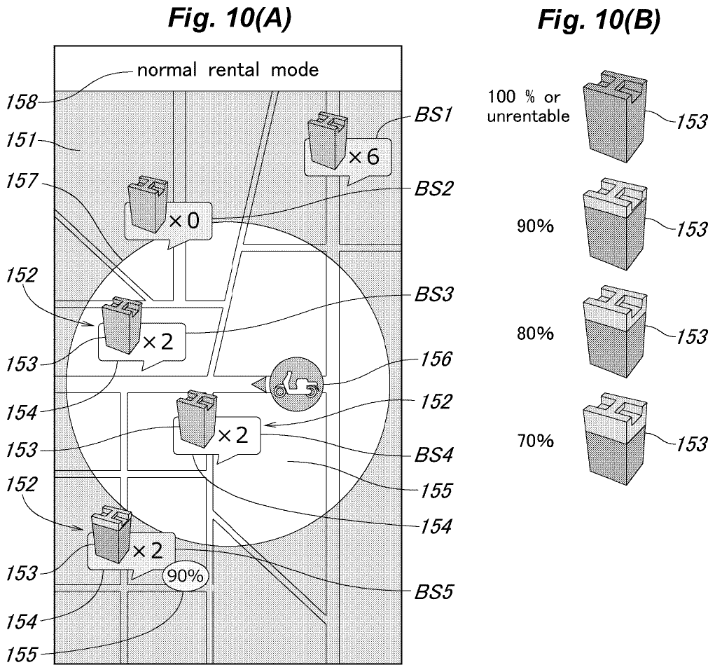

The station information presenter 54 presents the information on the battery stations to the users. In the present embodiment, the station information presenter 54 generates information on a station guidance screen (see FIG. 9 and FIG. 10) for guiding each user through the battery stations, and transmits this information to each user terminal 5, thereby causing the user terminal 5 to display the station guidance screen. This station guidance screen provides guidance on the locations of the battery stations and the number of battery packs 2 that can be exchanged at each battery station.

Also, the station information presenter 54 searches for a map of a target area from the entirety map of battery exchange service (map search). At this time, in the case where the user specifies a location in detailed search, the target area is set by using the specified location as a reference position. Also, in the case of an automatic search or in the case where the user does not specify a location in the detailed search, the target area is set by using the current position of the electric vehicle 1 as the reference position.

Further, the station information presenter 54 acquires information on each battery station to be a guidance target, namely, each battery station where it is determined, by the guidance suitability determiner 59, that the battery exchange satisfying the requirements of the user is possible and guidance on the battery exchange there should be provided to the user (battery station information acquisition).

Specifically, the station information presenter 54 acquires the position information of each battery station to be a guidance target. Also, in the case of the automatic search or in the case where the user does not specify the date and time in the detailed search, the station information presenter 54 acquires, by using the current date and time as the reference time point, information on the charging states of the battery packs 2 at the current time point in each battery station to be a guidance target, specifically, information such as the number of battery packs 2 that are charged and can be rented.

The system manager 55 monitors the status of the system, and presents the status of the system to the administrator and the maintenance person. For example, the system manager 55 generates a management screen to display the status of the system and transmits the management screen to each management terminal 6 and each maintenance terminal 7, thereby causing the management terminal 6 and the maintenance terminal 7 to display the management screen. Accordingly, the administrator and the maintenance person can check the status of the system.

The notification manager 56 manages notifications to each user. More specifically, the notification manager 56 transmits to each user terminal 5 guidance on the opening and closing of each battery station, guidance on maintenance work to be performed at the battery station, and guidance that battery exchange reservation cannot be made at the battery station due to a network failure or the like.

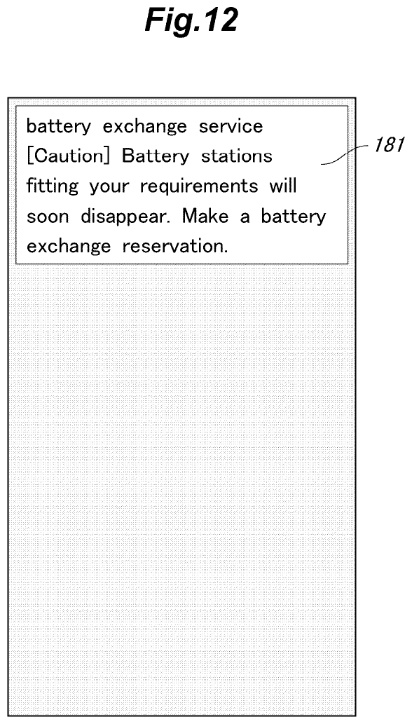

Further, the notification manager 56 determines whether a predetermined issuance condition is satisfied (issuance determination), and when the predetermined issuance condition is satisfied, issues an alert (notification of battery exchange guidance). This issuance of an alert is performed when the user specifies it. Also, in the present embodiment, an alert screen (see FIG. 12) is displayed on the user terminal 5 as the issuance of an alert.

Also, in the present embodiment, an alert is issued in the case where, as an issuance condition, it is predicted that the battery stations to be a guidance target, namely, the battery stations where it is determined, by the guidance suitability determiner 59, that the battery exchange satisfying the requirements of the user is possible and guidance on the battery exchange there should be provided to the user will disappear within a predetermined time. In this case, the guidance suitability determiner 59 performs guidance suitability determination based on the current time point and in addition performs guidance suitability determination based on a future time point after a predetermined time, thereby determining whether there is a battery station to be a guidance target after the predetermined time.

The reservation manager 57 manages the battery exchange reservation by each user. More specifically, the reservation manager 57 accepts the battery exchange reservation when the user performs a reservation operation on the user terminal 5. Also, the reservation manager 57 cancels the battery exchange reservation when the user performs a cancellation operation of the battery exchange reservation on the user terminal 5. Also, if the battery exchange is not performed within a prescribed period after acceptance of the battery exchange reservation, the reservation manager 57 forcibly cancels the battery exchange reservation.

The history analyzer 58 analyzes history information on the past state of charging and exchange of the battery packs 2 at each battery station, and acquires a sold out index as an analysis result. This sold out index indicates the degree of opportunity loss in which the battery exchange service could not be provided to the user at each battery station, namely, the degree of occurrence of a state in which there is no battery pack 2 that is charged and can be rented (unrentable state).

In the present embodiment, as the sold out index, the history analyzer 58 acquires a time period of occurrence of the unrentable state in unit time (for example, 1 hour). This time period of occurrence of the unrentable state in unit time corresponds to an average value of the waiting time for which the user waits at the battery station until the battery packs 2 that can be rented are prepared. Accordingly, in the present embodiment, the time period of occurrence of the unrentable state for each time range is processed as an estimated waiting time for each time range. Note that the analysis of history information is performed for the period specified by the user (for example, one week, one month, or one year).

On the other hand, it is possible to estimate the user's waiting time at each battery station based on the real-time information on the current battery charging state at each battery station. Specifically, it is possible to acquire, as the user's waiting time, a remaining time until the charging of the battery packs 2 being charged at the battery station completes (charging completion time). Therefore, the estimated waiting time may be acquired based on both the waiting time acquired from the real-time information (charging completion time) and the waiting time acquired from the history information (sold out index).

Specifically, it is possible to compare the waiting time acquired from the real-time information and the waiting time acquired from the history information and to adopt a greater one of them as the estimated waiting time. For example, in the case where the waiting time acquired from the real-time information is 3 minutes and the waiting time acquired from the history information is 7 minutes, the estimated waiting time is set to 7 minutes.

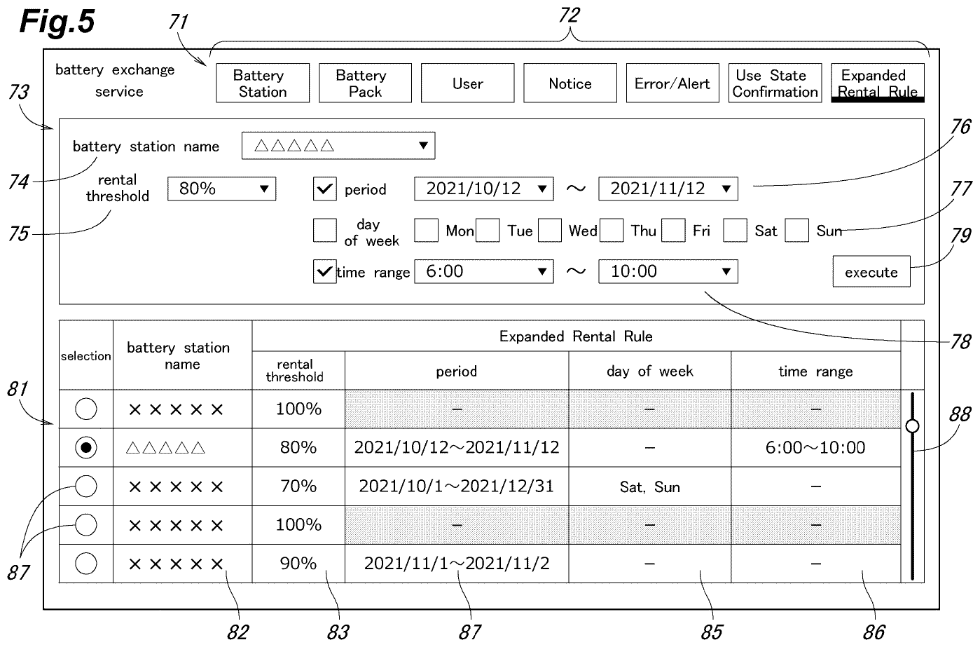

Further, the history analyzer 58 analyzes the history information on the past rental state of the battery packs 2 at each battery station and acquires setting information for controlling the expanded rental mode for each battery station. This setting information complements the administrator setting information acquired according to the input by the administrator on the management screen (FIG. 5). Particularly, the history analyzer 58 may acquire an expanded rental condition for each battery station by analyzing the history information. Also, the history analyzer 58 may derive the expanded rental condition from the history information by using an engine (machine learning model) constructed by machine learning such as deep learning.

The guidance suitability determiner 59 determines, based on the profile information and the like of the user, whether each battery station is a battery station to be a guidance target, namely, a battery station where the battery exchange satisfying the requirements of the user is possible and guidance on the battery exchange there should be provided to the user.

Specifically, the guidance suitability determiner 59 determines whether each battery station conforms to the battery configuration of the user, namely, whether there are the same or greater number of battery packs 2 that are charged and rentable as the number of battery packs 2 necessary for the electric vehicle 1 used by the user (battery configuration determination). Here, in the case where each battery station does not conform to the battery configuration of the user, namely, when the necessary number of battery packs 2 cannot be rented, the guidance suitability determiner 59 determines that the battery station is not a battery station to be a guidance target.

Note that in the present embodiment, the battery packs 2 of only one type are used in the battery exchange service, and thus the battery configuration of the electric vehicle 1 means the number of battery packs 2 fitted to the electric vehicle 1. However, the battery packs 2 of plural types (for example, with respect to the battery capacity) may be used in the battery exchange service. In such a case, the battery configuration includes not only the number of the battery packs 2 fitted to the electric vehicle 1 but also the types of the battery packs 2.

Also, the guidance suitability determiner 59 permits rental of the battery packs 2 at the battery exchanger 3 according to the rental mode. In the present embodiment, there are two rental modes, which are a normal rental mode and an expanded rental mode.

In the normal rental mode, the rental of the battery packs 2 is permitted only when there is a fully charged (charge completed) battery pack 2. Namely, in the normal rental mode, a fully charged battery pack 2 is determined to be rentable.

On the other hand, in the expanded rental mode, even when battery packs 2 are incompletely charged, the battery packs 2 are permitted to be rented if they satisfy a predetermined expanded rental condition. Here, in the present embodiment, as the expanded rental condition, a threshold (rental threshold) related to the state of charge of the battery packs 2, specifically, the lower limit of the state of charge of the battery packs 2 that are to be rentable is set. Also, as the expanded rental condition, an application condition of the rental threshold, specifically, a period, a day of week, and a time range for which the rental threshold is applied are set. In the present embodiment, the expanded rental condition can be specified by the administrator. The guidance suitability determiner 59 determines the battery packs 2 that can be rented based on such an expanded rental condition.

Further, when a predetermined transition condition is satisfied, the guidance suitability determiner 59 automatically switches the rental mode. Specifically, when there is no fully charged battery pack 2 at all of the battery stations in the travelable area and there is a battery pack 2 whose state of charge has reached the specified rental threshold at any of the battery stations in the travelable area, the rental mode automatically transitions from the normal rental mode to the expanded rental mode. Also, when a fully charged battery pack 2 appears at any of the battery stations located in the travelable area, the rental mode automatically transitions (returns) from the expanded rental mode to the normal rental mode. In the present embodiment, whether to permit the automatic transition of the rental mode can be set by the administrator.

In the present embodiment, it is possible to prohibit in advance the transition to the expanded rental mode for each battery station. Whether to prohibit the transition to the expanded rental mode can be set by the administrator.

Also, in the present embodiment, whether each battery station is positioned in an area where the electric vehicle 1 used by the user can travel (travelable area) is determined (area determination). At this time, a travelable distance of the electric vehicle 1 is acquired based on the acceptable remaining capacity of the battery packs 2 (the lower limit of the remaining capacity acceptable to the user) based on the exchange timing specified by the user, the actual remaining capacity of the battery packs 2 fitted to the electric vehicle 1 used by the user, and the electric mileage (the distance traveled per unit capacity of the battery packs 2) of the electric vehicle 1 used by the user. A circular region having this travelable distance as a radius thereof defines the travelable area.

Further, in the present embodiment, it is determined, based on the estimated waiting time for each battery station acquired by the history analyzer 58, whether battery packs 2 that are charged and rentable can be prepared within the waiting time requested by the user (acceptable waiting time) (waiting time determination).

Specifically, when the estimated waiting time at a battery station is shorter than the user's acceptable waiting time, the battery station is determined to be a battery station to be a guidance target. On the other hand, when the estimated waiting time at a battery station is longer than the user's acceptable waiting time, the battery station is determined not to be a battery station to be a guidance target.

This determination of whether each battery station is a battery station to be a guidance target, which is performed by the guidance suitability determiner 59, may be made with the reference time point being the current time point or with the reference time point being a future time point. Specifically, when the user's acceptable waiting time is 0 minutes in the case of automatic search, the current time point becomes the reference time point. On the other hand, when the user's acceptable waiting time is not 0 minutes in the case of automatic search or when a future time point is set as a reference time point for the search in the case of detailed search, the future time point becomes the reference time point.

Each user terminal 5 includes a display 61, an operation device 62, a communication device 63, a storage device 64, and a controller 65.

The display 61 displays various screens, for example, a screen for guiding the battery stations and a screen for the battery exchange reservation. The operation device 62 accepts various screen operations on the screen displayed on the display 61. The display 61 and the operation device 62 may consist of a touch panel display that integrates a display panel as the display 61 and a touch panel as the operation device 62.

The communication device 63 communicates with the management server 4 via the network.

The storage device 64 stores programs and the like to be executed by the processor that constitutes the controller 65.

The controller 65 consists of a processor, and performs various processes relating to guidance on the battery stations and the battery exchange reservation. Namely, in response to the screen operations on the operation device 62 by the user and based on the information transmitted from the management server 4, the controller 65 controls the display 61 to display a screen for guiding the location, etc. of each battery station, a screen for the battery exchange reservation, and the like.

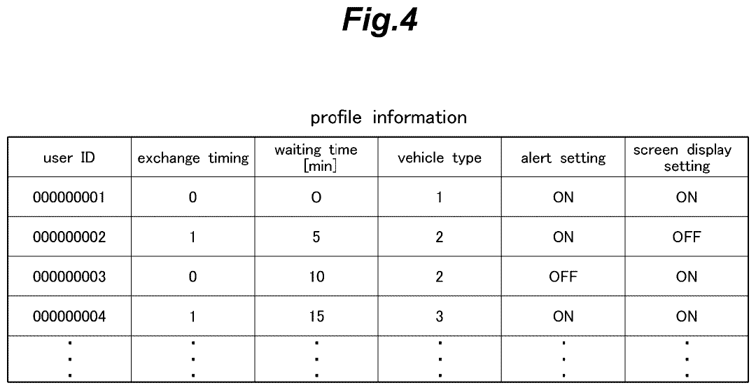

Next, the profile information managed by the user manager 51 of the management server 4 will be described. FIG. 4 is a block diagram showing the content of profile information for each user.

The user manager 51 of the management server 4 manages the profile information for each user. The profile information is information regarding the requirements of the user for battery exchange (preference, convenience, etc.). The profile information is acquired from the user terminal 5 according to an operation on the user terminal 5 by the user and is accumulated in the storage device 42 of the management server 4.

The profile information includes the user ID and the setting information regarding the exchange timing, waiting time, vehicle type, alert setting, and screen display setting. Note that provided that the fee grade for battery exchange service is set, the battery's degree of newness/oldness (deterioration degree), favorite areas, favorite battery stations, membership type, etc. may be included in the profile information.

In the user ID field, the user ID (user number) for identifying each user is registered. With this user ID, the membership information and the billing mode (payment for each exchange, fixed-price payment, or the like) related to the user who performs battery exchange can be acquired. Note that according to the user's billing mode, it is possible to determine behavior characteristics of the user related to battery exchange, such as the frequency of battery exchange.

In the exchange timing field, as a requirement of the user (preference, convenience, etc.) related to the battery exchange timing, either “frequent exchange” (setting value: 0) or “long ride” (setting value: 1) is registered. “Frequent exchange” is selected in a case where the user wishes to perform battery exchange in a state in which there is a sufficient margin in the remaining capacity of the battery packs 2. “Long ride” is selected in a case where the user wishes to perform battery exchange in a state in which the remaining capacity of the battery pack 2 is reduced to near the limit. In the present embodiment, the user's acceptable remaining capacity (the lower limit of the remaining capacity acceptable to the user) is decided from the exchange timing. For example, in the case of “frequent exchange,” the acceptable remaining capacity is set to 50%, and the time point at which the remaining capacity of the battery packs 2 becomes 50% is regarded as the timing when the battery exchange is to be performed. On the other hand, in the case of “long ride,” the acceptable remaining capacity is set to 30%, for example, and the time point at which the remaining capacity of the battery packs 2 becomes 30% is regarded as the timing when the battery exchange is to be performed. Note that the exchange timing for each user can be also estimated from the remaining capacity of the battery packs 2 returned in the past.

In the waiting time field, as a requirement of the user (preference, convenience, etc.) related to the waiting time, a length of the acceptable waiting time is registered. The acceptable waiting time is the maximum value of the waiting time acceptable to the user when the user waits at the battery station until the necessary number of battery packs 2 that are charged and rentable is prepared at the battery station. In the present embodiment, for example, the user is asked to select one of 0 minutes, 5 minutes, 10 minutes, and 15 minutes as the acceptable waiting time.

In the vehicle type field, information regarding the vehicle type of the electric vehicle 1 used by the user is registered. The vehicle type is, for example, a small car fitted with one battery pack 2 (setting value: 1), a medium car fitted with two battery packs 2 (setting value: 2), a large car fitted with four battery packs 2 (setting value: 3), or the like. From this information on the vehicle type, the number of battery packs 2 fitted to the electric vehicle 1 used by the user, namely, the number of battery packs 2 required by the user at the time of battery exchange can be acquired. Also, from the vehicle type, a rough electric mileage (the distance traveled per unit capacity of the battery packs 2) can be acquired.

In the alert setting field, the necessity of issuance of an alert for prompting the user to perform battery exchange (notification of battery exchange guidance) is registered. In the present embodiment, as the issuance of an alert, an alert screen (see FIG. 12) for notifying that a battery station fitting the requirements of the user will soon transition to a state in which the battery exchange cannot be carried out is displayed on the user terminal 5.

In the screen display setting field, the necessity of screen display of an area where the electric vehicle 1 used by the user can travel (travelable area) is registered. In the present embodiment, in the station guidance screen (see FIG. 9 and FIG. 10), a travelable area 157 can be displayed on an area map 151 (road map) representing the surrounding road conditions.

Next, the management screen displayed on the management terminal 6 will be described. FIG. 5 is an explanatory diagram showing the management screen (expanded rental rule setting screen) related to an expanded rental rule.

In the present embodiment, the management screen shown in FIG. 5 is displayed on the management terminal 6 when the management terminal 6 accesses and logs in the management server 4.

The management screen shown in FIG. 5 is provided with a menu selection part 71. The menu selection part 71 is provided with multiple tabs 72 representing respective menus. In the example shown in FIG. 5, there are tabs 72 labeled Battery Station, Battery Pack, User, Notice, Error/Alert, Use State Confirmation, and Expanded Rental Rule. The management screen shown in FIG. 5 is displayed upon operation of the tab 72 labeled Expanded Rental Rule.

When the tab 72 labeled Battery Station is operated, a station information list screen (not shown in the drawings) is displayed. On this station information list screen, information on the battery stations is displayed in list. Specifically, information such as the number of each battery station, the name of each battery station, the number, operating state, and network state of the battery exchangers 3 installed in each battery station, the charged pack number (the number of charged battery packs 2), abnormality of any battery exchanger 3, abnormality of any battery pack 2, etc. is displayed.

When the tab 72 labeled Battery Pack is operated, the screen transitions to a battery pack list screen (not shown in the drawings). On this battery pack list screen, information on the shared battery packs 2, specifically, the serial number of each battery pack 2, information on the location of each battery pack 2 (the user who is using the battery pack 2, or the battery exchanger 3 in which the battery pack 2 is stored), etc. are displayed.

When the tab 72 labeled User is operated, the screen transitions to a user list screen (not shown in the drawings). On this user list screen, information on each registered user, specifically, the user ID, name, age, sex, ID of the electric vehicle 1 in use, the information on each battery pack 2 in use (the battery pack ID, etc.), the registration date, etc. are displayed.

When the tab 72 labeled Notice is operated, the screen transitions to a notice list screen (not shown in the drawings). On this notice list screen, history information on the notices transmitted in the past, specifically, the notification dates, the notification contents, etc. are displayed. Also, it is possible to transition from the notice list screen to a notice registration screen. On this notice registration screen, a new notice can be registered. Specifically, registration operation is performed by inputting the title, display period, and content of the notice.

When the tab 72 labeled Error/Alert is operated, the screen transitions to an error/alert list screen (not shown in the drawings). On this error/alert list screen, history information on the errors and alerts outputted in the past in relation to the battery exchangers 3, specifically, output dates and times, output contents, etc. are displayed.

When the tab 72 labeled Use State Confirmation is operated, the screen transitions to a use state confirmation screen (not shown in the drawings). On this use state confirmation screen, the sold out index in each time range at each battery station, specifically, the time period of occurrence of the unrentable state in each time range, is displayed as the history analysis result. Note that on the use state confirmation screen, the administrator can specify the target period of history analysis.

Besides, a tab for transitioning to a screen for enabling search for the history of the user's use state or the history of the operation state of the system (history search), a tab for transitioning to a screen for enabling the administrator to make settings regarding maintenance work such as component replacement (maintenance setting), and the like may be provided.

Further, the management screen displayed when the tab 72 labeled Expanded Rental Rule is operated includes an expanded rental rule input part 73. The expanded rental rule input part 73 is provided with a battery station specifying part 74, a rental threshold specifying part 75, a period specifying part 76, a day-of-week specifying part 77, a time range specifying part 78, and an execute button 79.

In the battery station specifying part 74, the administrator can specify the target battery station by selecting from a pull-down menu.

In the rental threshold specifying part 75, the administrator can specify the rental threshold by selecting from a pull-down menu. Note that a lower limit (for example 70%) may be set to the rental threshold so that a value smaller than that cannot be selected. The initial value of the rental threshold is set to 100%. If the rental threshold is left unchanged at 100%, the transition to the expanded rental mode cannot take place, and the rental mode is fixed to the normal rental mode. On the other hand, if the rental threshold is set to be less than 100%, the transition to the expanded rental mode becomes possible. Also, for the battery station where the transition to the expanded rental mode is prohibited beforehand, the rental threshold is fixed to 100%, and the operation for changing the rental threshold cannot be performed.

In the period specifying part 76, the administrator can specify the target period (the start date and the end date) by selecting from a pull-down menu. In the day-of-week specifying part 77, the administrator can specify the target day of week by checking a checkbox. In the time range specifying part 78, the administrator can specify the target time range (the start time and the end time) by selecting from a pull-down menu.

The period specifying part 76, the day-of-week specifying part 77, and the time range specifying part 78 are respectively provided with checkboxes. By checking the checkboxes, the administrator can enable the specification in the period specifying part 76, the day-of-week specifying part 77, and the time range specifying part 78.

When the administrator operates the execute button 79 after performing necessary operations related to each item in the expanded rental rule input part 73, the setting information regarding the rental threshold and the condition (the period, the day of week, and the time range) under which the rental threshold is applied is registered as one expanded rental rule for the specified battery station.

Further, the management screen displayed when the tab 72 labeled Expanded Rental Rule is operated includes an expanded rental rule list display part 81. In the expanded rental rule list display part 81, one line represents one expanded rental rule. The expanded rental rule list display part 81 is provided with a battery station name display field 82, a rental threshold display field 83, a period display field 84, a day-of-week display field 85, and a time range display field 86.

The expanded rental rule list display part 81 is further provided with a radio button 87 for each expanded rental rule. When the administrator wants to update a registered expanded rental rule, the administrator selects the expanded rental rule by operating the radio button 87. Thereby, the content of the selected registered expanded rental rule is displayed in the expanded rental rule input part 73. This allows the content of the registered expanded rental rule to be changed.

The expanded rental rule list display part 81 is further provided with a scroll bar 88. By operating the scroll bar 88, the user can display the expanded rental rules that were outside the display area in the expanded rental rule list display part 81.

Note that in the initial state, one expanded rental rule is registered beforehand in relation to one battery station. In this expanded rental rule in the initial state, the rental threshold is set to 100%, and the period, the day of week, and the time range are not specified.

Also, it is possible to register multiple expanded rental rules in relation to one battery station. For example, in a case where the time range is changed depending on the day of week, it is possible to register an expanded rental rule for each day of week. Incidentally, in the case where multiple expanded rental rules are registered in relation to one battery station, control may be conducted by judging the conditions (the period, the day of week, and the time range) defined in the respective multiple expanded rental rules combined by AND or OR.

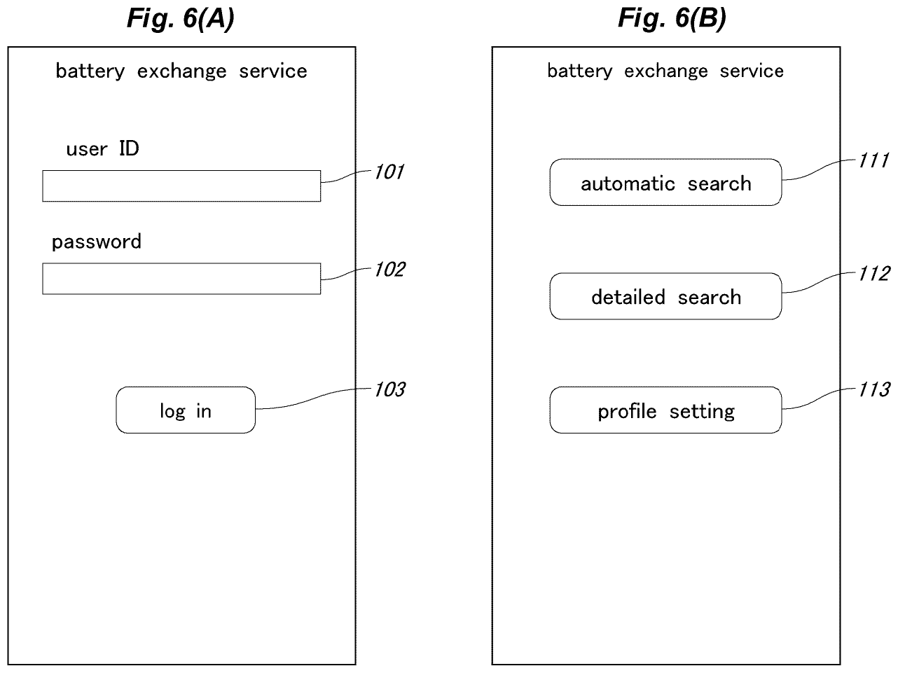

Next, a login screen and a start screen displayed on each user terminal 5 will be described. FIG. 6 is an explanatory diagram showing the login screen and the start screen.

The login screen shown in FIG. 6(A) is displayed on the user terminal 5 when the user terminal 5 accesses the management server 4. The login screen and its subsequent screens are displayed by an application (for example, a mobile terminal OS compatible app or a web browser) for station guidance installed on the user terminal 5.

The login screen is provided with a user ID input part 101, a password input part 102, and a login button 103. When each user inputs the user ID and the password and then operates the login button 103, the management server 4 performs the user authentication based on the input user ID and the password. Note that as the user ID, a mail address may be used besides a unique user number.

If the user authentication is successfully performed, the login screen transitions to the start screen (see FIG. 6(B)) in the user terminal 5.

The start screen (menu screen) shown in FIG. 6(B) is provided with buttons 111, 112, 113 for “automatic search,” “detailed search,” and “profile setting,” respectively.

When the “automatic search” button 111 is operated on the start screen, battery station search is conducted based on a prescribed search condition according to the profile information for each user acquired beforehand by the management server 4, and the screen transitions to the station guidance screen (see FIG. 9 and FIG. 10) for providing the user with guidance on the battery stations as the search result.

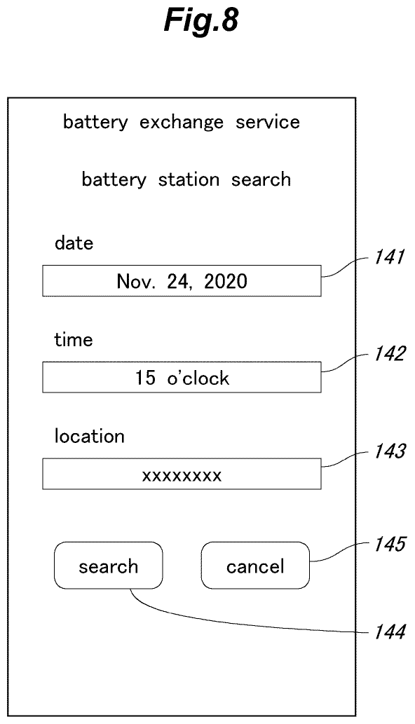

When the “detailed search” button 112 is operated, the screen transitions to a detailed search screen (see FIG. 8) for allowing the user to input his/her own search condition to make the management server 4 conduct battery station search based thereon.

When the “profile setting” button 113 is operated, the screen transitions to a profile setting screen (see FIG. 7(A)) for allowing the user to set her/his preference and convenience as a profile.

Next, the profile setting screen and the profile registration completion screen displayed on the user terminal 5 will be described. FIG. 7 is an explanatory diagram showing the profile setting screen and the profile registration completion screen.

The profile setting screen shown in FIG. 7(A) is displayed when an operation for selecting “profile setting” is performed on the start screen (see FIG. 6(B)).

The profile setting screen is provided with a user ID display part 121, an exchange timing selection part 122, a waiting time selection part 123, a vehicle type selection part 124, an alert necessity selection part 125, an area display necessity selection part 126, a decision button 127, and a cancel button 128.

In the user ID display part 121, the user ID (user number) related to the user who has logged in is displayed.

In the exchange timing selection part 122, with a pull-down menu, the user can select either “frequent exchange” (setting value: 0) or “long ride” (setting value: 1) according to the requirements of the user (preference, convenience, etc.) in relation to the timing when the battery exchange is to be performed. For example, in a case where the user does not want to worry about running out of electricity (a state in which the actual remaining capacity of the battery packs 2 runs out so that the travel becomes impossible), the user should select “frequent exchange.” Also, in a case where the user's billing mode is payment for each battery exchange, the user should select “long ride” because the cost for the battery exchange can be suppressed by using the batteries to the limit.

In the waiting time selection part 123, with a pull-down menu, the user can select the length of the acceptable waiting time (for example, 0 minutes, 5 minutes, 10 minutes, 15 minutes) according to the requirements of the user (preference, convenience, etc.).

In the vehicle type selection part 124, with a pull-down menu, the user can select the vehicle type of the electric vehicle 1 used by the user. The vehicle type includes, for example, a small car fitted with one battery pack 2 (setting value: 1), a medium car fitted with two battery packs 2 (setting value: 2), a large car fitted with four battery packs 2 (setting value: 3).

In the alert necessity selection part 125, with a pull-down menu, the user can select whether to issue an alert for prompting the user to perform battery exchange (ON or OFF).

In the area display necessity selection part 126, with a pull-down menu, the user can select whether to display the travelable area 157 on the station guidance screen (see FIG. 9 and FIG. 10) (ON or OFF). Note that in such cases as when the membership type can be identified based on the user ID or the like, a recommended setting (popular setting) may be selected beforehand and displayed on the profile setting screen, so that the user can change it according to his/her preference.

Here, when the user performs selecting operations in each part of the profile setting screen and operates the decision button 127, the management server 4 executes a process of registering the user input information as profile information. In response to this, the screen transitions to the profile registration completion screen (see FIG. 7(B)) in the user terminal 5. On the other hand, when the cancel button 128 is operated, the screen returns to the start screen (see FIG. 6(B)).

The profile registration completion screen shown in FIG. 7(B) is provided with characters 131 indicating that the profile registration is completed and a button 132 for instructing return to the start screen.

Next, the detailed search screen displayed on the user terminal 5 will be described. FIG. 8 is an explanatory diagram showing the detailed search screen.

The detailed search screen is displayed when the operation for selecting “detailed search” is performed on the start screen (see FIG. 6(B)).

The detailed search screen is provided with a date input part 141, a time input part 142, a location input part 143, a search button 144, and a cancel button 145.

In the date input part 141, the user can input a date (year, month, and day) as a search condition. Note that an arrangement may be made such that the date can be selected with a calendar screen or the like. In the time input part 142, the user can input a time as a search condition. Note that an arrangement may be made such that the current date and time are displayed in the initial state, and if the user does not specify the date and time, the battery station search is conducted with the current date and time. In the location input part 143, the user can input a location as a search condition. Note that an arrangement may be made such that each region in the service area can be selected with a pull-down menu or the like or a location can be specified from the entirety map of the service area.

Here, when the user inputs the search condition (date, time, location) and operates the search button 144, the management server 4 conducts battery station search based on the inputted search condition, and a station guidance screen (see FIG. 9 and FIG. 10) for providing guidance on the battery stations as the search result is displayed on the user terminal 5. On the other hand, when the cancel button 145 is operated, the screen returns to the start screen (see FIG. 6(B)).

Next, the station guidance screen displayed on each user terminal 5 will be described. FIGS. 9 and 10 are explanatory diagrams showing the station guidance screen. Here, FIG. 9(A), FIG. 9(B), and FIG. 10(A) show a transition of the station guidance screen. FIG. 10(B) shows a change of the display mode of the battery icon 153 according to the state of charge.

The station guidance screen is displayed when an operation for selecting automatic search is performed on the start screen (see FIG. 6(B)). The station guidance screen is also displayed when the search condition (date, time, location) is inputted and the search button 144 is operated on the detailed search screen (see FIG. 8).

On the station guidance screen, a guide map in which battery station display parts 152 are superimposed on the area map 151 (road map) is shown. Each battery station display part 152 includes a battery icon 153, a rentable number display part 154, and a rental threshold display part 155. In the rentable number display part 154, the number of battery packs 2 that are charged and can be rented at the corresponding battery station is displayed.

As shown in FIG. 10(B), the mode of the battery icon 153 changes according to the state of charge of the battery packs 2. In the battery icon 153, when the state of charge does not reach 100%, a free space is shown in a light color in an upper portion, and the free space becomes smaller as the state of charge increases. Thereby, the user can easily recognize the state of charge of the battery packs 2. Note that the current state of charge of the battery packs 2 may be displayed as text.

In the rental threshold display part 155, the rental threshold, namely, the lower limit of the state of charge of the battery packs 2 permitted to be rented is displayed. The rental threshold display part 155 is displayed when a battery pack 2 that is not fully charged can be rented in the expanded rental mode. On the other hand, when there is no battery pack 2 that can be rented in the expanded rental mode or when the rental mode is the normal rental mode because there is a fully charged battery pack 2, the rental threshold display part 155 is not displayed.

Further, in the station guidance screen, an electric vehicle icon 156 representing the current position of the electric vehicle 1 is displayed on the area map 151 in a superimposed manner. Note that the management server 4 acquires position information from the user terminal 5 and displays the electric vehicle icon 156 based on the position information.

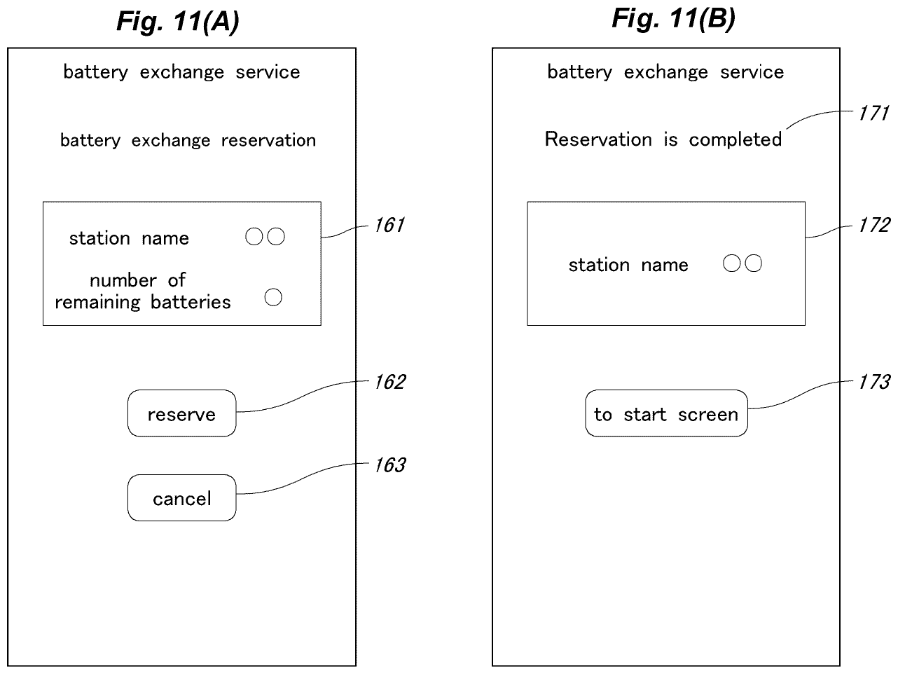

Further, in the station guidance screen, the user can perform an operation for selecting a battery station display part 152. At this time, when a battery station display part 152 is operated (for example, tapped), detailed information (a location, contact information, or the like) about the corresponding battery station is displayed. Also, when the battery station display part 152 is operated (for example, long press) on the station guidance screen, the screen transitions to a reservation screen (see FIG. 11(A)).

Further, in the station guidance screen, a travelable area 157 is displayed on the area map 151 (road map). This travelable area 157 is an area where the electric vehicle 1 used by the user can travel without battery exchange. In the example shown in FIG. 9 and FIG. 10, the travelable area 157 is displayed as a circular region having a radius equal to the travelable distance calculated based on the remaining capacity of the battery packs 2 fitted to the electric vehicle 1 about the current position of the electric vehicle 1 used by the user. Also, in the station guidance screen, an area outside the travelable area 157 is displayed in gray. The travelable area 157 is not displayed when the user disables the screen display thereof on the profile setting screen (see FIG. 7(A)).

Note that the travelable distance is a distance that the electric vehicle 1 can travel until the capacity of the battery packs 2 fitted to the electric vehicle 1 used by the user reaches the user's acceptable remaining capacity based on the exchange timing specified by the user. Therefore, the size of the travelable area 157 varies depending on the setting of the exchange timing. Namely, in the case of “frequent exchange,” the travelable distance is short, and hence, the travelable area 157 is small, and in the case of “long ride,” the travelable distance is long, and hence, the travelable area 157 is large.

Also, in the station guidance screen, the state of each battery station display part 152 changes depending on the result of the determination (guidance suitability determination) of whether the associated battery station is a battery station to be a guidance target, namely, a battery station where the battery exchange satisfying the requirements of the user is possible and guidance on the battery exchange there should be provided to the user.

Specifically, when the associated battery station is a battery station to be a guidance target, the battery station display part 152 is turned into a valid state, and the rentable number display part 154 is displayed in a color (for example, blue) representing the valid state. On the other hand, when the associated battery station is a battery station where the battery exchange satisfying the requirements of the user cannot be carried out and guidance on the battery exchange there should not be provided to the user, the battery station display part 152 is turned into an invalid state, and the rentable number display part 154 is displayed in a color (for example, gray) representing the invalid state.

Also, in the present embodiment, when the battery station display part 152 is in the valid state, an operation for selecting the battery station display part 152 is possible, and it is possible to cause the detailed information regarding the battery station to be displayed or to cause the screen to transition to the reservation screen (see FIG. 11(A)) for making a reservation of battery exchange at the battery station. On the other hand, when the battery station display part 152 is in the invalid state, an operation for selecting the battery station display part 152 cannot be performed.

The station guidance screen is provided with a rental mode display part 158. In the rental mode display part 158, the current rental mode (the normal rental mode or the expanded rental mode) is displayed. Thereby, the user can confirm the current rental mode.

Here, FIG. 9(A), FIG. 9(B), and FIG. 10(A) show one example of transition of the station guidance screen with the passage of time. In the station guidance screen, the battery stations BS1 to BS5 are displayed, but here, description will be made focusing on the battery stations BS3, BS4, and BS5.

The battery station BS3 is located in the travelable area 157. At the battery station BS3, the rental threshold is set to 80%.

At the battery station BS3, there is no battery pack 2 whose state of charge has reached the rental threshold of 80% at the time point shown in FIG. 9(A), and accordingly, the rentable number display part 154 indicates 0. On the other hand, at the time point shown in FIG. 9(B), the state of charge of two battery packs 2 reaches the threshold of 80%, and accordingly, the indication by the rentable number display part 154 increases to 2. In addition, the rental threshold display part 155 is displayed, and the rental threshold of 80% is displayed on the rental threshold display part 155. At the time point shown in FIG. 10(A), the state of charge of two battery packs 2 has reached 100%, and accordingly, the rental mode transitions to the normal rental mode and the rental threshold display part 155 is not displayed.

The battery station BS4 is located in the travelable area 157. At the battery station BS4, the rental threshold is set to 70%.

At the battery station BS4, there are two battery packs 2 whose state of charge reaches the rental threshold of 70% at the time point shown in FIG. 9(A), and accordingly, the rentable number display part 154 indicates 2. In addition, the rental threshold display part 155 is displayed, and the threshold of 70% is displayed on the rental threshold display part 155. At the time point shown in FIG. 9(B), the state of charge of the battery packs 2 has increased to 90% but there is no change in the display state of the rentable number display part 154 and the rental threshold display part 155. At the time point shown in FIG. 10(A), the state of charge of the battery packs 2 has reached 100%, and accordingly, the rental mode transitions to the normal rental mode and the rental threshold display part 155 is not displayed.

The battery station BS5 is located outside the travelable area 157. At the battery station BS5, the rental threshold is set to 90%. Since the battery station BS5 is located outside the travelable area 157, the rentable number display part 154 is displayed in gray.

At the battery station BS5, there are four battery packs 2 whose state of charge reaches the rental threshold of 90% at the time point shown in FIG. 9(A), and accordingly, the rentable number display part 154 indicates 4. In addition, the rental threshold display part 155 is displayed, and the threshold 90% is displayed on the rental threshold display part 155. On the other hand, at the time point shown in FIG. 9(B), the state of charge of two battery packs 2 has reached 100%, and accordingly, the rental mode transitions to the normal rental mode, and the rental threshold display part 155 is not displayed. Further, at the time point shown in FIG. 10(A), the two battery packs 2 whose state of charge is 100% are rented, and there is no longer a battery pack 2 whose state of charge is 100%. However, since there remain two incompletely charged battery packs 2 whose state of charge reaches the rental threshold of 90%, the rentable number display part 154 indicates 2. Also, the rental mode transitions to the expanded rental mode, and accordingly, the rental threshold display part 155 is displayed, and the rental threshold of 90% is displayed on the rental threshold display part 155.

Note that the example shown in FIG. 9(A), FIG. 9(B), and FIG. 10(A) assumes a case where the number of battery packs 2 fitted to the electric vehicle 1 of interest is two, namely, the battery packs 2 are rented in units of two. In this case, the number of battery packs 2 that can be rented is displayed as an even number. On the other hand, in a case where the electric vehicle 1 of interest may be fitted with one battery pack or three or more battery packs, the display of the number of battery packs 2 that can be rented is not limited to even numbers. Also, in a case where the electric vehicle 1 of interest may be one of electric vehicles fitted with different numbers of battery packs 2, the screen display may be changed depending on the number of battery packs 2 fitted to the electric vehicle 1 used by the user. Specifically, for example, in the case where the number of battery packs 2 fitted to the electric vehicle 1 used by the user is three, the number of battery packs 2 that can be rented is displayed as a multiple of three.

Next, the reservation screen and the reservation completion screen displayed on the user terminal 5 will be described. FIG. 11 is an explanatory diagram showing the reservation screen and the reservation completion screen.

The reservation screen shown in FIG. 11(A) is displayed when an operation for selecting one of the battery stations is performed on the station guidance screen (see FIG. 9 and FIG. 10), specifically, when one of the battery station display parts 152 is operated (tapped).

The reservation screen is provided with a station information display part 161, a reserve button 162, and a cancel button 163. In the station information display part 161, information on the battery station, specifically, the battery station name, the number of battery packs 2 that are charged and rentable (the number of remaining batteries) are displayed.

When the user confirms the information on the battery station and operates the reserve button 162, the management server 4 executes a process for accepting the battery exchange reservation. When the reservation is completed at the management server 4, the screen of the user terminal 5 transitions to the reservation completion screen (see FIG. 11(B)). When the cancel button 163 is operated, the screen returns to the station guidance screen (see FIG. 9 and FIG. 10).

The reservation completion screen shown in FIG. 11(B) is provided with a reservation completion notification part 171, a battery station information display part 172, and a button 173 for instructing return to the start screen. In the reservation completion notification part 171, characters for notifying the user that the reservation is completed are displayed. In the battery station information display part 172, information on the battery station, specifically, the battery station name is displayed. When the user confirms that the reservation is completed and operates the button 173, the screen returns to the start screen (see FIG. 6(B)).

Next, the alert screen displayed on the user terminal 5 will be described. FIG. 12 is an explanatory diagram showing the alert screen.

The management server 4 issues an alert (the battery exchange guidance the notification) when the predetermined issuance condition is satisfied. In the present embodiment, the alert screen shown in FIG. 12 is displayed on the user terminal 5 as the issuance of an alert.

In the alert screen, a notification box 181 is displayed. The notification box 181 is pop-up displayed on a standby screen in a superimposed manner, for example. In the notification box 181, characters representing that a battery station fitting the requirements of the user will soon transition to a state in which the battery exchange cannot be carried out and characters prompting to make a battery exchange reservation are displayed.

Thereby, it is possible to avoid inconvenience that even though there is a battery station where the battery exchange is possible, the electricity runs out before arriving at the battery station.

Note that it is possible to compare the acceptable remaining capacity based on the exchange timing specified by the user with the actual remaining capacity of the battery packs 2 fitted to the electric vehicle 1 used by the user and to issue an alert when the actual remaining capacity becomes equal to or less than the acceptable remaining capacity. In this case, preferably, characters prompting to perform battery exchange immediately are displayed on the alert screen.

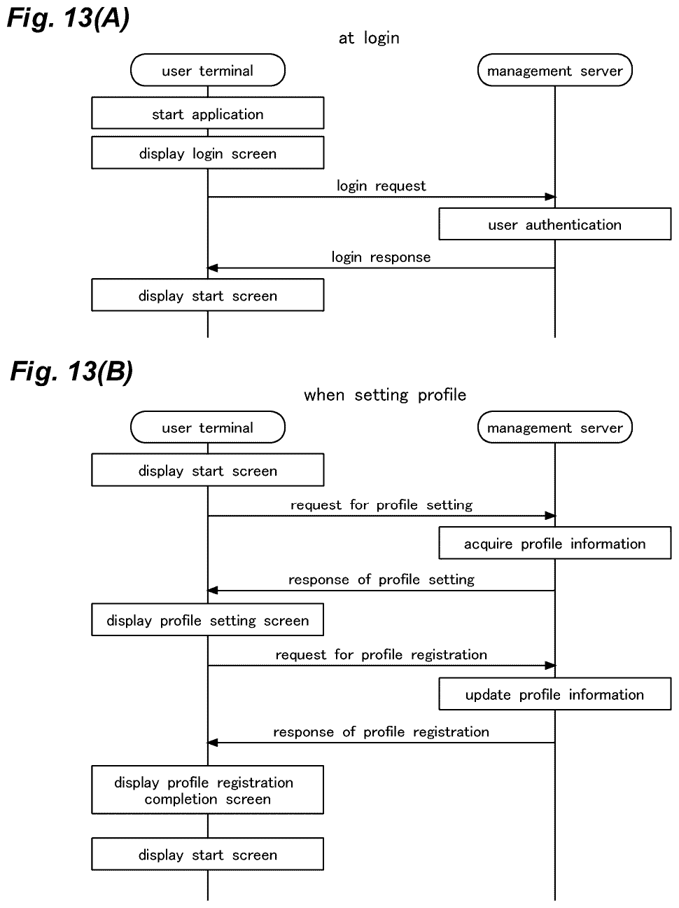

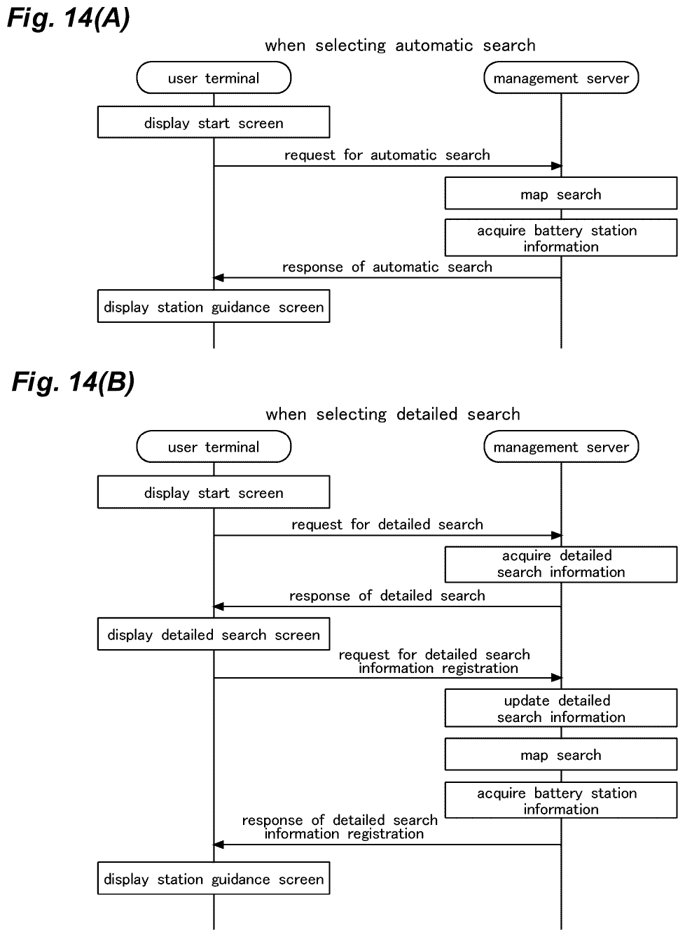

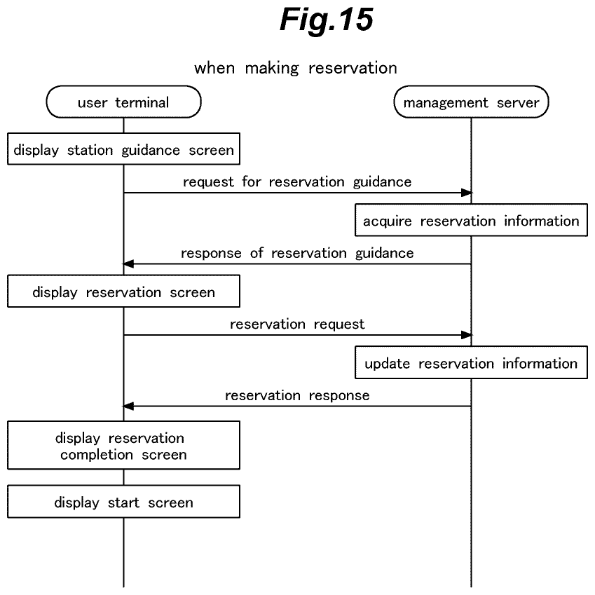

Next, operation procedures of the user terminal 5 and the management server 4 will be described. FIG. 13 is a sequence diagram showing operation procedures of the user terminal 5 and the management server 4 at login and when the profile is set. FIG. 14 is a sequence diagram showing operation procedures of the user terminal 5 and the management server 4 when automatic search is selected and when detailed search is selected. FIG. 15 is a sequence diagram showing operation procedures of the user terminal 5 and the management server 4 when a reservation is made.

First, description will be made of the operation procedures at login will be described. In this case, as shown in FIG. 13(A), first, upon starting an application for station guidance, the user terminal 5 displays the login screen (see FIG. 6(A)). When the user performs a login operation on this login screen, the user terminal 5 transmits a login request to the management server 4.

Upon receiving the login request from the user terminal 5, the management server 4 performs the user authentication based on the user ID and the password included in the login request, and transmits a login response to the user terminal 5.

Upon receiving the login response from the management server 4, the user terminal 5 displays the start screen (see FIG. 6(B)) in a case where the user authentication is successfully performed and the login is approved. In a case where the user authentication fails, the user terminal 5 displays an error screen (not shown in the drawings).

Next, the operation procedures when the profile is set will be described. In this case, as shown in FIG. 13(B), when the user performs an operation for selecting profile setting on the start screen (see FIG. 6(B)), the user terminal 5 transmits a request for profile setting to the management server 4.

Upon receiving the request for profile setting from the user terminal 5, the management server 4 acquires the profile information of the corresponding user if the corresponding user has already set the profile. Then, the management server 4 transmits a response of profile setting to the user terminal 5. This response includes the profile information of the corresponding user. Note that at the time of first profile setting, a response not including the profile information is transmitted.

Upon receiving the response of profile setting from the management server 4, the user terminal 5 displays the profile setting screen (see FIG. 7(A)) based on the information included in the response. Subsequently, when the user performs selecting operations and an operation for instructing the profile registration on the profile setting screen, the user terminal 5 transmits a request for profile registration to the management server 4. This request includes screen operation information (input information) of the user on the profile setting screen.

Upon receiving the request for profile registration from the user terminal 5, the management server 4 updates the profile information of the corresponding user based on the information included in the request. Note that at the first profile setting, the profile information is newly registered. Then, the management server 4 transmits a response of profile registration to the user terminal 5.

Upon receiving the response of profile registration from the management server 4, the user terminal 5 displays the profile registration completion screen (see FIG. 7(B)). Then, when the user performs an operation for transitioning to the start screen (see FIG. 6(B)), the screen of the user terminal 5 returns to the start screen.

Next, the operation procedures when the automatic search is selected will be described. In this case, as shown in FIG. 14(A), when the user performs an operation for selecting automatic search on the start screen (see FIG. 6(B)), the user terminal 5 transmits a request for automatic search to the management server 4.

Upon receiving the request for automatic search from the user terminal 5, the management server 4 sets a target area by using the current position of the electric vehicle 1 as the reference position and searches for the map of the target area (map search). Subsequently, the management server 4 acquires the position information of each battery station located in the target area, and acquires the information on the charging states of the battery packs 2 at the current time point at each battery station (battery station information acquisition). Then, the management server 4 transmits a response of automatic search to the user terminal 5. This response includes the map of the target area and the information on each battery station located in the target area. Upon receiving the response of automatic search from the management server 4, the user terminal 5 displays the station guidance screen (see FIG. 9 and FIG. 10) based on the information included in the response.

Next, the operation procedures when the detailed search is selected will be described. In this case, as shown in FIG. 14(B), when the user selects the detailed search on the start screen (see FIG. 6(B)), the user terminal 5 transmits a request for detailed search to the management server 4.

Upon receiving the request for detailed search from the user terminal 5, the management server 4 acquires detailed search information if the corresponding user has already conducted detailed search. Then, the management server 4 transmits a response of detailed search to the user terminal 5. This response includes the detailed search information of the corresponding user.

Upon receiving the response of detailed search from the management server 4, the user terminal 5 displays the detailed search screen (see FIG. 8) based on the information included in the response. When the user inputs the search condition (use date and time, use location) and performs an operation for instructing search on the detailed search screen, the user terminal 5 transmits a request for detailed search information registration to the management server 4. This request includes the screen operation information (input information) of the user on the detailed search screen.

Upon receiving the request for detailed search information registration from the user terminal 5, the management server 4 updates the detailed search information regarding the corresponding user based on the information included in the request. Also, the management server 4 sets a target area using the location specified by the user as the reference position and searches for the map of the target area (map search).

Subsequently, the management server 4 acquires the information (position information and the like) on each battery station located in the target area (battery station information acquisition). Then, the management server 4 transmits a response of detailed search information registration to the user terminal 5. This response includes the map of the target area and the information on each battery station located in the target area.

Upon receiving the response of detailed information registration from the management server 4, the user terminal 5 displays the station guidance screen (see FIG. 9 and FIG. 10) based on the information included in the response.

Next, the operation procedures when a reservation is made will be described. In this case, as shown in FIG. 15, when the user performs an operation for selecting a battery station on the station guidance screen (see FIG. 9 and FIG. 10), the user terminal 5 transmits a request for reservation guidance to the management server 4. This request includes the information on the battery station selected by the user.

Upon receiving the request for reservation guidance from the user terminal 5, the management server 4 acquires reservation information (information regarding battery exchange reservation) of the battery station selected by the user based on the information included in the request. Then, the management server 4 transmits a response of reservation guidance to the user terminal 5. This response includes the reservation information of the relevant battery station, specifically, the name of the battery station and the number of batteries that are charged and can be rented (the number of remaining batteries).

Upon receiving the response of reservation guidance from the management server 4, the user terminal 5 displays the reservation screen (see FIG. 11(A)) based on the information included in the response. Subsequently, when the user performs an operation for instructing reservation on the reservation screen, the user terminal 5 transmits a reservation request to the management server 4.

Upon receiving the reservation request from the user terminal 5, the management server 4 updates (confirms) the reservation information of the relevant battery station. Then, the management server 4 transmits a reservation response to the user terminal 5. Note that by updating the rental order list of the battery packs 2 or the like according to the update (confirmation) of the reservation information and transmitting the updated rental order list or the like to the battery exchanger 3, rental control of the battery packs 2 to the user can be performed.

Upon receiving the reservation response from the management server 4, the user terminal 5 displays the reservation completion screen (see FIG. 11(B)). Then, when the user performs an operation for transitioning to the start screen (see FIG. 6(B)), the screen of the user terminal 5 returns to the start screen.

As described above, in the present embodiment, when an event related to battery exchange, specifically, an event of providing guidance on the battery station where the user performs battery exchange or an event of issuing an alert for prompting the user to perform battery exchange occurs, the management server 4 refers to the setting information (profile information) regarding the requirements of the user for battery exchange and the sold out index, and displays the station guidance screen or the alert screen on the user terminal 5 as a notification screen related to the event.

Thereby, guidance on the battery station where the user performs battery exchange and output of an alert prompting the user to perform battery exchange can be executed in a manner that fits the requirements of the user (preference, convenience, etc.), and thus, the user convenience can be enhanced. Further, since the index representing a degree of unrentable state at each battery station is referred to, the notification screen related to the event can be properly displayed.

The present invention has been described in terms of a specific embodiment, but is not limited by such an embodiment, and can be modified, substituted, added and omitted in other embodiments. Also, a new embodiment may be created by combining various components of the foregoing embodiment.

For example, in the present embodiment, guidance on the battery stations where the battery exchange is possible was provided based on the expanded rental condition set by the administrator, but guidance on the battery stations may be provided based on the expanded rental condition set by the user in addition to the expanded rental condition set by the administrator. For example, arrangement may be made such that in the case where the user does not set the expanded rental condition, guidance on the battery stations is provided based on the expanded rental condition set by the administrator, and in the case where the user sets the expanded rental condition, the expanded rental condition set by the user is applied in preference to the expanded rental condition set by the administrator.

### INDUSTRIAL APPLICABILITY

The battery management system, the battery management method, and the terminal device according to the present disclosure have the effect that it is possible to provide sufficient information to the user regarding expanding the range of battery devices permitted to be rented and renting incompletely charged battery devices which are normally not rented in a case where there is a shortage of fully charged battery devices at battery stations, and are useful as a battery management system and a battery management method for managing battery stations and battery devices, a terminal device carried by each user, or the like in a battery exchange service which enables users of electric vehicles or the like to exchange battery devices at battery stations.

### LIST OF REFERENCE NUMERALS

1 electric vehicle
2 battery pack (battery device)
3 battery exchanger (battery exchange device)
4 management server (server device)
5 user terminal (terminal device)
6 management terminal
54 station information presenter
57 reservation manager
73 expanded rental rule input part
75 rental threshold specifying part
76 period specifying part
77 day-of-week specifying part
78 time range specifying part
81 expanded rental rule list display part

1. A battery management system, comprising:
a plurality of battery exchange devices located in respective battery stations and configured to store and charge battery devices returned by users and to rent charged battery devices to the users in exchange for the returned battery devices;
a server device connected to the plurality of battery exchange devices via a network and configured to manage exchanging states of the battery devices at the battery exchange devices; and
a terminal device carried by a user and connected to the server device via the network,
wherein the server device is configured to
store setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station,
control, by referring to the setting information, switching between the expanded rental mode and a normal rental mode which permits rental of only fully charged battery devices at each battery station, and
display a guidance screen on the terminal device, the guidance screen providing the user with guidance on the battery stations based on control of the rental mode thereof and including information on a transition state to the expanded rental mode at each battery station.

2. The battery management system according to claim 1, wherein the server device is configured to cause the terminal device to display the guidance screen in which battery stations where rental of the battery devices is possible in the expanded rental mode are superimposed on a map.

3. The battery management system according to claim 1, wherein the server device is configured to
hold, based on specification by the administrator, setting information regarding prohibition of transition to the expanded rental mode for each battery station, and
control the expanded rental mode at each battery station based on the setting information.

4. The battery management system according to claim 1, wherein the server device is configured to acquire information regarding battery exchange reservation according to an operation by the user on the guidance screen displayed on the terminal device.

5. The battery management system according to claim 1, wherein the server device is configured to control the expanded rental mode at each battery station based on based on the setting information including, as the expanded rental condition, a rental threshold which is a lower limit of a state of charge for permitting rental of the battery devices in the expanded rental mode, and an application condition related to at least one of a period, a day of week, and a time range.

6. The battery management system according to claim 1, wherein the server device is configured to determine whether transition to the expanded rental mode should be permitted by analyzing history information regarding a past rental status at each battery station.

7. A battery management method used by a server device for managing battery stations where users exchange battery devices and for managing the battery devices, the battery management method comprising:
storing setting information for managing an expanded rental mode for each battery station based on specification by an administrator, wherein the expanded rental mode permits rental of incompletely charged battery devices satisfying a predetermined expanded rental condition in a case where there is a shortage of fully charged battery devices at each battery station;
controlling, by referring to the setting information, switching between the expanded rental mode and a normal rental mode which permits rental of only fully charged battery devices at each battery station; and
displaying a guidance screen on a terminal device, the guidance screen providing the user with guidance on the battery stations based on control of the rental mode thereof and including information on a transition state to the expanded rental mode at each battery station.

8. A terminal device carried by a user and connected to a server device via a network,
the terminal device being configured to display a guidance screen that provides the user with guidance on battery stations according to control of switching between an expanded rental mode which permits rental of incompletely charged battery devices satisfying a predetermined expanded rental condition in a case where there is a shortage of fully charged battery devices at each battery station and a normal rental mode which permits rental of only fully charged battery devices at each battery station, and includes information on a transition state to the expanded rental mode at each battery station, the control being conducted by the server device based on specification by an administrator.
